(19) United States
(12) Patent Application Publication
(10) Pub. No.: US 2013/0138497 A1
(43) Pub. Date: May 30, 2013

(54) CUSTOMER LOYALTY SYSTEM IN RETAIL CHAINS AND RESTAURANTS USING WEB SERVERS, MOBILE COMMUNICATION DEVICES, AND POINT-OF-SALE TERMINALS

(71) Applicants: David Yan, Moscow (RU); Maxim Nalskiy, Moscow (RU)

(72) Inventors: David Yan, Moscow (RU); Maxim Nalskiy, Moscow (RU)

(21) Appl. No.: 13/704,468

(22) PCT Filed: Jun. 15, 2011
(86) PCT No.: PCT/IB11/02046

§ 371 Date: Feb. 13, 2013

Related U.S. Application Data
(60) Provisional application No. 61/355,077, filed on Jun. 15, 2010.

(51) Int. Cl. G06Q 30/02

(52) U.S. Cl. CPC G06Q 30/0231
USPC 705/14.31; 705/14.35

(57) ABSTRACT

A customer loyalty system assists to build and keep a customer base. The system gathers feedback from customers and enables tracking of goods and services. The customer loyalty system rids a customer of multiple loyalty cards by replacing them with one account. A customer account is associated with, for example, a customer cell phone number. A short [symbol] lived promotional code enables the customer to pay through a virtual wallet and to receive bonus points or rewards. A point of sale (POS) system generates a bill with a short-lived active promotional or activation code. The code identifies the currently ordered or selected goods or services at a particular establishment. The code expires after a few minutes or other relatively short time. Through, for example, a mobile Internet-enabled device, a customer redeems the short-lived code. Redemption may be done in a variety of ways, and may be done before or after payment, but before code expiration.

### CROSS-REFERENCE TO RELATED APPLICATIONS

For purposes of the USPTO extra-statutory requirements, the present application constitutes a continuation-in-part of U.S. Patent Application No. 61/355,077, titled A METHOD FOR BUILDING A CUSTOMER LOYALTY SYSTEM IN RETAIL CHAINS AND RESTAURANTS USING WEB SERVERS, MOBILE COMMUNICATION DEVICES, AND POINT-OF-SALE TERMINALS CONNECTED TO THE INTERNET, naming David Yan, Max Nalsky and Artyom Yukhin as inventors, filed 15 Jun. 2010.

The United States Patent Office (USPTO) has published a notice effectively stating that the USPTO's computer programs require that patent applicants reference both a serial number and indicate whether an application is a continuation or continuation-in-part. Stephen G. Kunin, Benefit of Prior-Filed Application, USPTO Official Gazette 18 Mar. 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND OF THE INVENTION

1. Field of the Invention

The invention relates to systems and methods for strengthening customer loyalty in restaurant and retail chains and in other establishments providing goods and services to customers.

2. Related Art

In traditional customer loyalty systems, a customer is usually given a plastic bonus card that the customer then presents when making a payment to a restaurant, restaurant chain, store, retail establishment, wholesale establishment or other similar type company (hereinafter “company”), perhaps one that is a member of a franchise or chain of stores. Upon presentation of the card, the customer may receive bonus points, discounts, and the like.

Typically, customers own many bonus cards issued by different companies. In some companies, the loss of a bonus card by a customer results in the loss of accumulated bonus points and discounts. Additionally, a lost bonus card may be misused be a company's staff or by any other ill-intentioned person that may find it. If the bonus card is associated with a virtual wallet, credits may be lost.

Another drawback of existing customer loyalty systems includes a lack of a means of connecting customers to a social network. Further, loyalty cards do not provide any means for customers to communicate their opinion about the quality of the consumed goods or services directly to the company, and do not enable the company to gather reliable data on consumption of and demand for its specific goods or services.

From the perspective of a company, such company would like to collect certain personal data. Such information might include information to identify and contact customers such as name, phone number, email address, home address or other geographic locator, photograph, date of birth, sex, and identification of friends or relatives who typically accompany the customer, etc. Many companies already collect consumption information such as what services have been consumed, goods bought, preferences, and details related to each purchase such as the day of week, date of the year, hour of the day, etc. However, a company often cannot connect this information reliably with customers because of the problems associated with loyalty cards.

In terms of applying for a loyalty card, certain existing loyalty systems and companies use paper application forms. Often, a company employee enters the data from the form. Mistakes can be made during data entry assuming that the customer provided correct and legible information. Companies using paper-based forms are saddled with the extra cost of entering or scanning the customer identifying data. Other existing loyalty systems engage and invite customers to fill out an online application form. However, there are many shortcomings with this arrangement. Customers frequently ignore the invitation to do so or forget to do so. When customers do so, the customer does not do so within a reasonable time after a purchase, thus information associated with any recently purchased product or service is lost and unconnectable with a newly issued loyalty card. Further, customers may not enter data in all of the available fields on the online form leaving companies with incomplete customer identification information. As a result, there is a low conversion of customers to known and trackable customers with whom companies can meaningfully engage.

Once a loyalty card has been issued, it is often used at the point of sale by swiping it through a machine to read its magnetic strip or barcode. Frequently, customers complain of having too many loyalty cards to carry in their wallets and thus forget to bring them shopping.

While there may soon be barcodes on screens of mobile devices or devices using near field technology, there are also drawbacks with the use of these devices and technologies. For example, in a restaurant, a customer is required to bring his phone or device near a cash register or point of sale terminal that can detect the device. Customers are not likely to entrust a waiter with their phone! Thus, there is likely to be a low conversion of information gathered and a low availability of information about a purchase and connectable to an appropriate customer. A dialogue or repeat interaction between such a company and customer is lost.

These and other shortcomings of the current art are overcome by use of the present invention.

### SUMMARY

A customer loyalty system, device and method for consumers of goods and services (e.g. guests of restaurants, retail establishments and the like) are disclosed. The customer loyalty system assists to build and keep a customer base. The customer loyalty system enables establishments to gather feedback from customers, to obtain reliable information about the quality of the goods and services offered and about the consumption of goods and services by customers. The customer loyalty system enables establishments to optionally create customer social networks. The customer loyalty system described herein may be implemented with, for example, a Web site and related services, one or more mobile communication devices with Internet access (such as but not limited to cell phones), and point-of-sale (POS) terminals, among others as more fully described herein.

The customer loyalty system, device and method rid a customer of multiple club, bonus, discount, and similar types of cards (“loyalty cards”) enabling the customer to receive various privileges from retail outlets, restaurants, gas stations, agencies, etc., by replacing these cards with one account in a loyalty system, the said account being associated with, for example, a customer cell phone number.

The customer loyalty system is able to respond to and interact with registered customers. For example, once the customer enters a code, the loyalty system is able to recognize or acknowledge that the customer is near or otherwise ready to interact with the loyalty system.

In one implementation, a short-lived active promotional code enables the customer to pay for goods and services from his account in the system (such as through a “virtual wallet”) and to accumulate bonus points on this account. An establishment or company is able to aggregate consumption data and correlate or connect with data associated with a registered customer. A point of sale (POS) system prints a bill with the short-lived active promotional code or activation code. This short-lived active promotional code identifies the currently ordered or selected goods or services at the particular establishment. Further, the POS system or device uploads, stores, transmits or sends a corresponding list of goods, services or goods and services of the bill (and provided to the customer) and associates the list with a particular short-lived active promotional code. The POS system may upload, store, transmit or send the entire list of goods, services or goods and services, an identifier of the bill, or other code that can be used to match one or more of the goods, services or goods and services with the promotional code. The POS system or device may be loaded or pre-loaded with a certain number of promotional codes and thus may operate offline. When re-connected, the POS system or device may then be accessed or directed to divulge its bills, lists of goods and services, associated information and promotional codes that were used and unused.

The short-lived active promotional code expires after a few minutes or a relatively short time (e.g., seconds, minutes, hours, days, or weeks depending on the needs or desires of a particular company or business). A customer receives the bill with the short-lived active promotional code. Through, for example, a mobile Internet-enabled device, a customer redeems the short-lived active promotional code. Redemption may be done in a variety of ways, and may be done before or after payment, but before code expiration.

After expiration of the code, a customer may also access the loyalty system from any mobile communication device or computer connected to the Internet or other network by authenticating with the customer loyalty system. The customer may then access his one or more virtual wallets. In one implementation, each virtual wallet is associated with a separate establishment or chain of similarly named establishments.

This Summary introduces a non-exclusive selection of concepts and aspects of the customer loyalty system, device and method in a simplified form that are further described below in the Detailed Description. This Summary is not intended to identify key or essential features of the claimed subject matter, and it is not intended to be used to limit the scope of the claimed subject matter.

### BRIEF DESCRIPTION OF THE DRAWINGS

The novel features believed characteristic of the subject matter are set forth in the appended claims. Throughout, like numerals refer to like parts with the first digit of each numeral generally referring to the figure which first illustrates the particular part. The subject matter and a preferred mode of use are best understood by reference to the following Detailed Description of illustrative implementations when read in conjunction with the accompanying drawings.

FIG. 1 is a diagram of an exemplary implementation of a customer loyalty system.

FIG. 2 is a diagram of another exemplary implementation of a customer loyalty system.

FIG. 3 is a diagram of an exemplary computer system or hardware and/or software with which a customer loyalty system may be implemented.

### DETAILED DESCRIPTION OF THE INVENTION

The present invention is directed to a customer loyalty system (herein “system” or “loyalty system”) for consumers of goods and services (e.g. guests of restaurants, retail establishments, gas stations, agencies, and the like—herein “companies”) aimed to build and keep a customer base. The customer loyalty system enables such restaurants, retail establishments and the like to gather feedback from customers and to obtain reliable information about the quality of the goods and services offered and about the consumption of goods and services by customers. The customer loyalty system enables companies to expand a customer base, and to, optionally, create customer social networks and participate in existing customer networks using the techniques described herein. The customer loyalty system described herein may be implemented with, for example, a Web site, database, Web or other server, one or more mobile communication devices with Internet access (such as but not limited to cell phones), and point-of-sale (POS) terminals, among others as more fully described herein.

The customer loyalty system rids a customer of multiple club, bonus, discount, and similar types of cards (“loyalty cards”) enabling the customer to receive various privileges from companies by replacing one or more cards with an account in a loyalty system, the said account being associated with, for example, a customer's cell phone number.

One feature of the customer loyalty system is the ease of access to the loyalty system. For example, once a customer registers with the system, the system is able to recognize the customer automatically or in a programmatic way. For example, once the customer enters a code, then the loyalty system is able to recognize or acknowledge that the customer is near or otherwise ready to interact with the loyalty system.

In an exemplary implementation, an active promotional code enables the customer to pay for goods and services from his account in the system (such as through a “virtual wallet”) and to accumulate bonus points, reward points, frequently flyer miles, etc. on this account. The customer may also access the loyalty system from any mobile communication device or computer connected to the Internet or other network by authenticating with the system—for example, entering a login and password or other credential—in which case the customer gets access to his one or more virtual wallets. In the exemplary implementation, each virtual wallet is associated with a separate establishment or a chain connected to or participating in the loyalty system. However, for compatibility with earlier or other systems, the use of previously issued plastic cards may be supported.

Referring now to the figures, implementations of the invention are described in detail. In referring to the figures, like numerals refer to like parts.

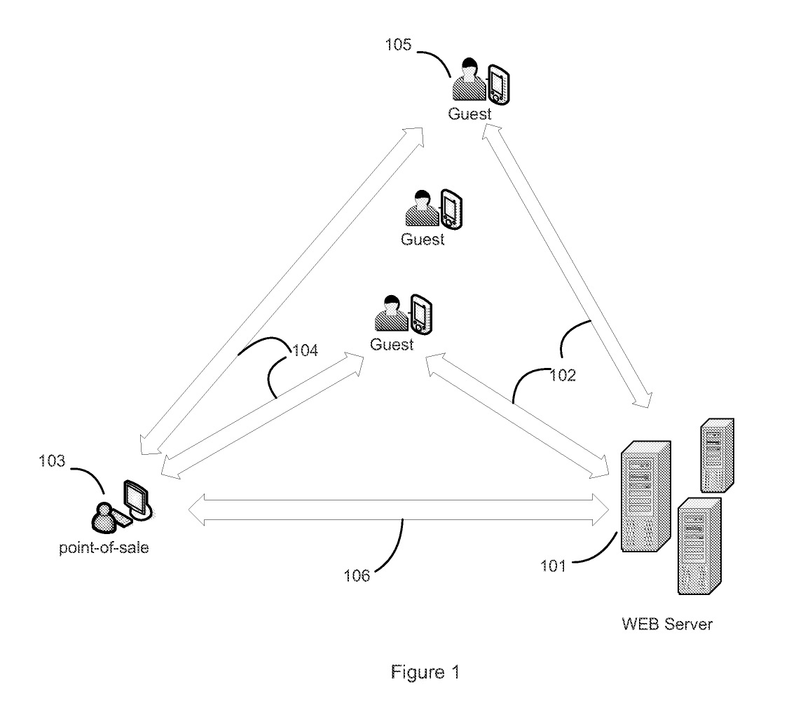

FIG. 1 is a diagram of an exemplary implementation of a customer loyalty system illustrating some of its aspects in a scenario involving a restaurant. FIG. 1 shows some of the technical means that may be used to implement such a customer loyalty system. With reference to FIG. 1, the system itself may be accessible as an Internet resource (such as a Web site) hosted on one or more Web or other type of servers 101 (hereinafter “Web server”). The Web server 101 hosts or is electronically in communication with a database (Card Server) (not shown) of customers, which contains information about the customers, their virtual wallets, orders, history of visits, etc. The Web site is accessed from one or more point-of-sale terminals 103 and from customer mobile communication devices (e.g., cell phones, tablets, smart phones, laptops) 105, or from any other device connectable to the Internet or through another means or protocol. While not shown, a point-of-sale terminal 103 may also be connected to or in communication with a server that operates a restaurant management system. Such restaurant management server stores and manages information about orders, their origins, availability of tables, active promotional codes, etc.

Communications 102 between customers 105 and the Web server 101 enable the customers 105 to access their virtual wallets and the promotional codes of their meal or other orders (goods or services). Via one or more communications 102, customers optionally may order additional dishes, ask for their bill, pay all or part of their bill using their virtual wallet, receive a bonus (e.g., receive a discount on the current or future order), buy a dish for a friend, and rate the dishes, the establishment, the waiter, the information services, etc.

In an exemplary scenario, a customer who has previously registered with the system and provided information regarding a bank account or credit card, upon receiving a promotional code (either electronically or on paper), enters the promotional code into an application or user interface of a portable electronic device, which was also previously registered, recorded or associated with the customer. The customer activates or sends the promotional code through a communication 102 to the Web server 101. The promotional code alone may trigger a subsequent communication 102 to the customer, as long as the promotional code was activated within the limited time. The subsequent communication 102 requests authorization from the customer to pay the bill (for the order) by charging the bill to the customer's credit card or bank account associated with the customer or account with the restaurant. Activation of the promotional code alone may trigger payment if the customer has configured such action to take place. Alternatively, if the customer has agreed or configured his account in the system accordingly, activation of the promotional code automatically charges the bill to the account, credit card or virtual wallet. After the limited time, there is no such prompt and no such automatic payment. The limited time may be just a few minutes in such a scenario, or may be longer depending on the desires of the administrator or company using the system. In this scenario, the system may prompt a customer 105 to confirm his identity, confirm an amount to be paid, ask if an additional gratuity (tip) is to be added to the amount paid, etc. If the promotional code is activated by an unregistered device, the system may prompt for the identity of the customer activating the promotional code and allows one customer to pay for an order of another customer. Thus, while a first customer initiated the order with a waiter, another or second customer may use the promotional code to pay for the order. A promotional code may be passed from device to device, and from customer to customer in a peer-to-peer fashion. Any of the customers may then activate the promotional code. Once a promotional code has been activated, the system expires the promotional code, at least for payment purposes, and may or may not expire the promotional code in terms of granting of a discount or other promotional offer.

In another implementation, customers may receive and accumulate reward points associated with a particular company for purchasing goods, services or goods and services from the particular company. One company may opt to allow exchanges of these points for cash or for exchange for reward points of another company. Through the Website 101, a customer may exchange points such as from one account to another or from one virtual wallet to another. Companies can set exchange rates and may do so through the system Website 101. In another implementation, participating companies may set exchanges rates for traditional currencies so that they could offer, for example, a two percent discount to customers who pay through their virtual wallet or through the reward system, virtual wallet and use of promotional codes. In another implementation, customers may exchange reward points with each other in a peer-to-peer fashion. For example, a single member of a family may aggregate reward points from other members of the family so that a single member of the family may receive a free meal at a participating restaurant. In principle, each company, business or participating establishment can have its own currency. The amount of money in this currency is effectively its liability to its customers. Thus, a company's liabilities can be traded, traditional cash payments may be eliminated or reduced.

Communications 102 facilitate interactions between customers via the Web server 101. Such customers 105 may be customers that are currently consuming or have recently consumed restaurant goods and/or services (such as within a few minutes, hours, days, etc.). According to another aspect, customers 105 may interact with any other customer having an account in the system and who have patronized a particular establishment. Further, the Web server 101 enables customers 105 to engage in an online text or voice chat with each other.

Communications 104 between a point-of-sale terminal 103 or an administrator terminal (not shown) accessible by a waiter and a device used by a customer 105 enable printing, downloading or otherwise accessing or saving of a receipt. For example, a customer 105 may download a copy of the receipt to his cellular phone. In a preferred implementation, the receipt includes a promotional code as described more fully herein and below.

Other communications 106 transfer information between the Web server(s) 101 and one or more point-of-sale terminals 103. Such other communications 106 may include information about, for example, payment of customer bills (and optionally bonus points granted), completed orders and bonuses, rewards or discounts issued during a particular period, food or service rankings assigned by customers, customer preferences, etc.

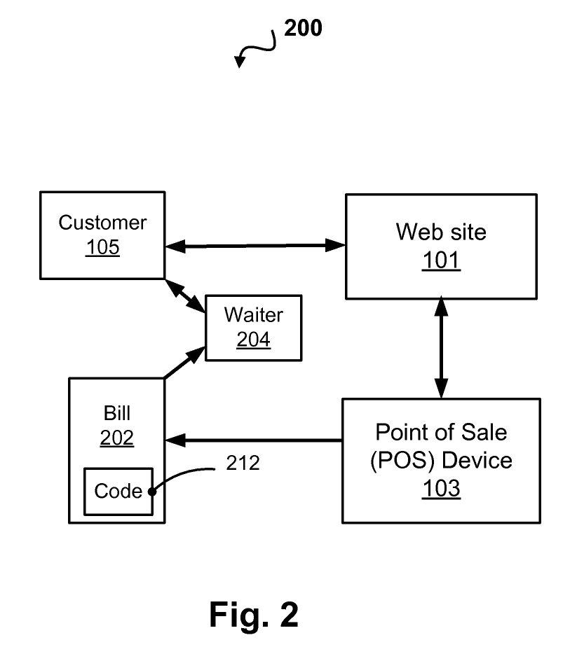

FIG. 2 shows another exemplary implementation of a customer loyalty system 200 illustrating some of its aspects. With reference to FIG. 2, a guest or customer 105 joins the loyalty system 200 as follows. During his or her first visit to a restaurant or other establishment, the customer 105 receives a bill 202 from a waiter or cashier for goods or services purchased or consumed. In such implementation, the bill 202 includes an invitation to join the loyalty system 200 to thereby become eligible to receive a discount on the current order, a first order or a subsequent order. As another example, by use of a promotional code, a registering customer receives a free dessert or other reward including an instant reward.

To join the loyalty system 200, the customer 105 visits the Web site 101 of the loyalty system 200, enters requested information and submits this information via a registration function or user interface element. Such may be done through a smartphone or other Web enabled device (not shown). Preferably, registration occurs while the customer is still in the restaurant.

Alternatively, for registration, a customer 105 sends an SMS text message from his cellular phone that corresponds ideally with the cellular phone number assigned to that device. In a preferred implementation, the SMS text message includes a promotional code 212 that was printed or otherwise made available on or through the bill 202. Thus, the promotional code 212 is associable or connected with the goods or services ordered and itemized on the bill 202. The customer cell phone number serves as an authentication mechanism such as a login, user identification, account name, account identifier or authentication scheme.

As one example, the promotional code 212 is a short sequence of letters and/or digits, e.g. a 2, 3, 4, 5, 6 or other-length-digit, character sequence, number or the like. The promotional code 212 may also be a two- or three-dimensional code, picture, etc. For example, a promotional code may be a quick response code or QR code, a bar code or non-human readable code. The promotional code 212 may also be printed with a non-human-visible ink or other material that is detectable by a consumer device. Thus a near field detector, RFID detector and the like may be used to detect, access and use such a promotional code 212. In a preferred implementation, the promotional code 212 is generated by the POS terminal or device 103 using one or more algorithms. In one particular implementation, one of the one or more algorithms involves random number generation to generate a promotional code 212. In another implementation, the Web site 101 generates promotional codes 212. Use of a promotional code may involve manually entering an alphanumeric code, resending an electronically delivered promotional code or may involve scanning or photographing a promotional code.

The promotional code 212 serves as a unique ID of the order in a given restaurant and, preferably, must be activated by the customer within a short period of time after the customer receives the promotional code 212 or a short time after generation of the promotional code 212. Otherwise, the promotional code 212 is or may be recycled. A promotional code 212, or a combination of promotional code 212 and one or more other numbers or digits, may be used to uniquely identify, for example, the following: an order at a particular establishment, an order and patron at a particular establishment, an order across all establishments registered with the system, etc. Such unique identity is for a particular time interval. A time interval may be just a few minutes, a few hours, a few days, a few weeks, etc. Thus, a promotional code 212 may be unique across all establishments or may be semi-unique in the system 200 across all times or within a time interval.

Activating the promotional code 212 provides a discount on the order or bonus points for the order, or some other benefit or combination of benefits. All promotional codes 212 activated by or put in use by establishments (a variety of retailers, restaurants, etc.) connected to or registered with the loyalty system are known to the system 200 (e.g., to the Web server 101).

Upon joining the loyalty system 200, a customer 105 is registered with the system 200, and the system 200 uses the customer cell phone number (for example) as his account identifier or login. After registration, the customer 105 gets access to his account in the loyalty system 200 and can enter additional personal data, review and change it and supervise one or more virtual wallets. Subsequently, when a customer 105 accesses the loyalty system 200, the system recognizes each customer 105 by his cell phone number, which is likely a unique number in the loyalty system 200. Alternatively, an email-address, unique nickname or one or more other personal data may be used to identify a customer account in the loyalty system 200.

In a subsequent visit to the restaurant, a customer 105 who already has an account in the loyalty system 200 may get immediate access to information about his order by asking the waiter 204 for the promotional code 212 of the newly created food order. The waiter 204 or an employee that registers orders provides the customer 105 with the promotional code 212 generated upon creating the order. The customer 105 may access the information about his order through his smart phone (such as through an application operating on the smart phone, via SMS text message or some other way), Internet enabled device, traditional phone or other device. For example, after entering or otherwise using the promotional code 212, the customer 105 may access his order from his device by seeing or receiving a status indicator (e.g. “in progress” or “ready”). Through the use of the promotional code 212, the customer 105 may order additional items if desired (dishes, goods, services, etc.), because the promotional code 212 remains active during a period of time after its creation, for example, 20 minutes, one hour, two hours, several hours, one day, etc. The delivery of a promotional code 212 may be done with or without delivery of a customer's receipt or bill, and may be delivered on paper or electronically such as through an SMS text message, email message, through an application operating on a customer's smart phone or voice message to a traditional phone. A customer 105 may use the loyalty system 200 to discover how much money he has in his virtual wallet, and pay his bill from this virtual wallet, by credit card, or by using another method of payment.

Further, once registered with a loyalty system, a customer may view a menu of a restaurant where he is currently at and may view current promotional offers that are available from the restaurant that are only offered to registered members of the loyalty system 200. If the customer orders an item via the restaurant's Web site 101 or loyalty system 200 (instead of through a waiter or other traditional means), the customer may receive bonus points and discounts on the entire order, possibly in addition to any promotion or discount offered for connecting with or using the loyalty system.

In another implementation of the loyalty system 200, a member or customer 105 may also receive additional bonus points by attracting new customers (e.g. friends, family) to a restaurant M at which the customer 105 is registered. In one exemplary scenario to attract a new customer, an existing customer 105 authenticates with restaurant M's Web site 101 or system 200, pays for a dish or drink, and specifies that the dish or drink is intended for a customer with a particular cell phone number N. The recipient or person associated with cell phone number N receives an SMS text message at the cell phone number N inviting him to restaurant M, and notifying him of the dish or drink that has been bought for him there. The SMS text message may contain the special promotional code of the order. The new prospective customer is required to visit restaurant M, register with the loyalty system 200, and enter the special promotional code into the loyalty system 200. Once the promotional code is accepted, the new customer will see his active pre-paid order. Bonus points for customers who invite their friends to the restaurant may be calculated, for example, as a percentage of the sums of orders subsequently placed by the invitees. Bonus points and rewards are awarded for friends and other persons that subsequently sign up. In yet a further implementation, rewards for attracting and promoting the registration of friends of friends may be given in a fashion akin to pyramid selling rewards. Thus, a first registered customer may accumulate substantial rewards for referring new customers to a particular establishment through the loyalty system 200.

Management of a particular restaurant may issue special promotional codes to grant bonus points to its registered customers or may raise their bonus priorities. To this end, a restaurant's waiter or employee enters one or more parameters and causes the POS terminal or device 103 to issue a particular, special bonus (such as a number of bonus points or a bonus percentage). The special bonus may include a time to live prior to activation, a bonus time to live after activation, etc. A generated promotional code may be printed on a printer and handed over to a customer or may be delivered electronically to the particular customer. When the patron or customer enters or uses the special promotional code associated with the loyalty system, he receives the granted bonuses after fulfilling any particular requirements (if any). This type of promotional code may be granted for free or may require purchase of a good or service or require a customer to purchase this type of promotional code. This type of promotional code may be generated in batches so that, for example, all customers in a particular restaurant in a block of time receive or are eligible for a particular special promotion, promotional code or special bonus. For example, a special batch of codes may be generated and be active for a Happy Hour event at a restaurant.

Additionally, a customer may access the loyalty system without entering a promotional code if the customer is currently not on the premises of a participating establishment, an establishment that is a member of the loyalty system. The customer is still able to view the statuses of his virtual wallets, see promotional offers from the loyalty system restaurants and stores, and possibly, depending on the customer's current location or the location specified by the customer as a preferred destination, see the menus of the corresponding restaurants, the availability of tables to be booked, etc. For example, the customer may book a table and order a dish for a certain time and pay for it from the virtual wallet. At any moment, the customer will be able to see the rankings of the loyalty system restaurants as entered by other members of the loyalty system community. Additionally, the customer may view his restaurant-going history, e.g. which restaurants he visited and when and what dishes he ordered there, and his history of “gifts” to and from friends. Upon making a payment for an order, a customer may have a small questionnaire sent to his account such as to his mobile or other registered device.

In another implementation, if a customer makes certain information about himself known to the loyalty system, for example his name, his photo, or a code word, the customer will be rewarded with extra features. For example, one of these features is the ability to make payments from one or more of his virtual wallets without using a promotional code.

In fast-food restaurants or in a store where payments are made at a POS terminal, the system will automatically detect the customer if his cell phone is turned on using near field technology, a cellular telephone technology, a GPS technology, etc. If the customer expresses his wish to pay from his virtual wallet and/or to receive the applicable discount, the cashier will only need to authenticate the customer by his name, photo, code word or using other suitable information.

Additionally, the use of the loyalty system may prevent fraudulent actions by third parties and, in particular, by employees of the establishments. In traditional customer loyalty systems, a lost bonus card may often be used by any person that finds it without any authentication or cross reference to other information. The loyalty system requires that the user not only knows the right promotional code, but also owns or possesses the customer device (e.g., cell phone) or provides an identifier (e.g., cell phone number) that was used to register with the loyalty system at this specific place. To further prevent fraud, a location of the given cell phone may be checked by using a geo-location technology, such as GPS, A-GPS or SBAS. The cell phone numbers of restaurant staff are usually known and may be blocked in the loyalty system, at least when the cell phones of the restaurant staff are in physical proximity to the restaurant and when the restaurant staff are working. In case of doubt, one or more additional checks or authentication mechanisms may be applied based on the supplied credentials—for example, additional questions may be sent to the customer by SMS or an account verification may be made through a partnership with a respective mobile carrier (provider).

The loyalty system 200 may also be configured to build, maintain and facilitate a customer social network. The social network may include such functions as Internet Relay Chat (IRC) or other type of chat, a blog, or a customer review forum, recommendation forum, “check-in” tallies and the like. When a registered customer engages with the loyalty system at a participating restaurant, the customer may receive or access a current status indicator for each of his friends or for each of any other registered customer that is also participating at the participating restaurant. Alternatively, the registered customer be able to receive or access a current status indicator for any other registered customer that is in the vicinity of the registered customer. There is provided an option whereby a registered customer's status is set to “invisible” such that other registered customers are not updated as to a registered customer's location or participation at a particular restaurant. Participating customers may be able to send other registered customers personal messages, or make a posting on a common bulletin board for the particular establishment. In this manner, a registered customer may notify his friends or other members of the loyalty system community about his intention to make a future visit to a particular restaurant.

The loyalty system enables companies to gather accurate information about their customers such as their gender, age, occupation, frequency of visits, preferences, and other participating restaurants visited. Using such data, a loyalty system may provide a company information that a company could use to determine how the company ranks among other similar establishments, get reliable data about the quality of work of his employees (bartenders, waiters, chefs), and learn what customers liked and what customers disliked.

### Exemplary Device

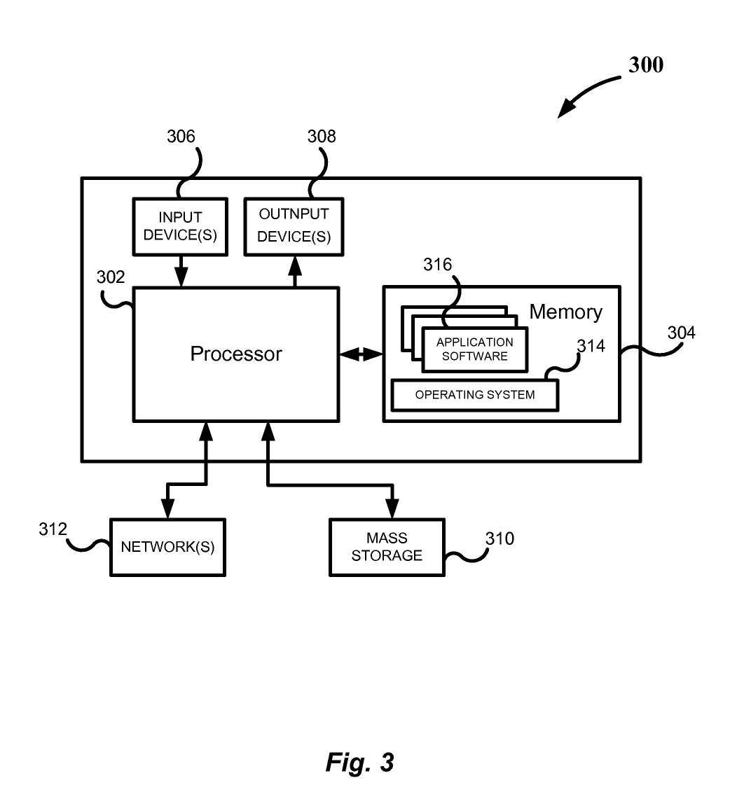

FIG. 3 of the drawings shows an exemplary hardware 300 or device that may be used to implement the present invention. Referring to FIG. 3, the hardware 300 typically includes at least one processor 302 coupled to a memory 304. The processor 302 may represent one or more processors (e.g. microprocessors), and the memory 304 may represent random access memory (RAM) devices comprising a main storage of the hardware 300, as well as any supplemental levels of memory, e.g., cache memories, non-volatile or back-up memories (e.g. programmable or flash memories), read-only memories, etc. In addition, the memory 304 may be considered to include memory storage physically located elsewhere in the hardware 300, e.g. any cache memory in the processor 302 as well as any storage capacity used as a virtual memory, e.g., as stored on a mass storage device 310.

The hardware 300 also typically receives a number of inputs and outputs for communicating information externally. For interface with a user or operator, the hardware 300 may include one or more user input devices 306 (e.g., a keyboard, a mouse, imaging device, scanner) and a one or more output devices 308 (e.g., a Liquid Crystal Display (LCD) panel, a sound playback device (speaker)).

For additional storage, the hardware 300 may also include one or more mass storage devices 310, e.g., a floppy or other removable disk drive, a hard disk drive, a Direct Access Storage Device (DASD), an optical drive (e.g. a Compact Disk (CD) drive, a Digital Versatile Disk (DVD) drive) and/or a tape drive, among others. Furthermore, the hardware 300 may include an interface with one or more networks 312 (e.g., a local area network (LAN), a wide area network (WAN), a wireless network, a cellular network (not shown) and/or the Internet among others including all of the devices or equipment necessary to carry out network communication) to permit the communication of information with other computers or devices coupled to the networks. It should be appreciated that the hardware 300 typically includes suitable analog and/or digital interfaces between the processor 302 and each of the components 304, 306, 308, and 312 as is well known in the art.

The hardware 300 operates under the control of an operating system 314, and executes various computer software applications, components, programs, objects, modules, etc., to implement the techniques described above. In particular, the computer software applications may include a client application, in the case of the client user device or smart phone 302. Moreover, various applications, components, programs, objects, etc., collectively indicated by reference 316 in FIG. 3, may also execute on one or more processors in another computer coupled to the hardware 300 via a network 312, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instruction sets at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash memory, etc.), among others. Another type of distribution may be implemented as Internet downloads.

Systems, devices and methods have been described for facilitating the display or use of displaying or using text and other information in a format that substantially appears as originally displayed or found on or in a medium (e.g., screen, television, paper, book, newspaper, fax, sign, photograph, magazine, etching, sculpture). Throughout, for sake of simplicity in explanation, reference is made to text and/or words. However, text and words refer generally to any information that is capable of being perceived, identified, recognized or used and may be found in or on any medium. While a smart phone is referred to herein, it is merely exemplary. It is to be understood that “smart phone” refers to any device that cannot display an actual sized representation of the menu 202 or to a device with a relatively small display (e.g., tablet, laptop, appliance).

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

While the invention has been described with respect to a preferred implementation, other implementations are possible. The concepts disclosed herein apply equally to other non-described systems, devices and methods for displaying or using text (and information generally) in a format that substantially appears as originally displayed or found on or in a medium. Furthermore, the concepts applied herein apply more generally to displaying or using text and breaking adjacent text at word and other logical boundaries such as at, near or around a character or element. The invention is described below with reference to the accompanying figures.

The foregoing discussion has been presented for purposes of illustration and description. Various features from one implementation can be combined with other features from other implementations. The description is not intended to limit the invention to the form or forms disclosed herein. Consequently, variation and modification commensurate with the above teachings, within the skill and knowledge of the relevant art, are within the scope of the present invention. The implementations described herein and above are further intended to explain the best mode presently known of practicing the invention and to enable others skilled in the art to use the invention as such, or in other implementations, and with the various modifications required by their particular application or uses of the invention. It is intended that the appended claims be construed to include alternate implementations to the extent permitted.

1. A method comprising:
generating a promotional code that is active for a limited time;
associating the promotional code with an order for goods or services;
sending the promotional code that is active for the limited time;
receiving an indication of use of the promotional code within the limited time; and
sending an indication of a customer loyalty reward to a customer after receiving the indication of use of the promotional code within the limited time.

2. The method of claim 1 wherein the method for providing a customer loyalty reward to a customer further comprises:
automatically charging a financial account associated with the customer after receiving the indication of use of the promotional code within the limited time.

3. The method of claim 1 wherein the sending the promotional code that is active for the limited time includes sending the promotional code in an electronic form to an account associated with the customer.

4. The method of claim 1 wherein the sending the promotional code includes electronically sending the promotional code to a device accessible by the customer.

5. The method of claim 1 wherein the sending the promotional code includes sending a paper to the customer.

6. The method of claim 1, wherein the method for providing a customer loyalty reward to a customer further comprises:
generating a bill for goods or services, wherein the promotional code is associated with the bill for goods or services or with an identifier of at least one of the goods or services.

7. The method of claim 1 wherein the promotional code includes a series of digits, and wherein the promotional code is unique for the limited time across all customer orders for a company associated with the customer loyalty reward.

8. The method of claim 1 wherein the promotional code includes a series of digits, and wherein the promotional code is unique for the limited time across all customer orders for all participating companies.

9. The method of claim 1 wherein the promotional code includes a series of digits, and wherein the promotional code is unique for the limited time across all customer orders for all participating companies.

10. The method of claim 1, wherein sending the promotional code that is active for the limited time includes sending the promotional code to a social network account of the customer, the account being part of a social network.

11. The method of claim 1, wherein the promotional code is associated with a business, and wherein the customer loyalty reward is dependent on a number of times that the customer has interacted with the business.

12. The method of claim 11, wherein the customer loyalty reward is dependent on an amount of money that the customer has transacted with the business over a period of time or in a current transaction.

13. The method of claim 11, wherein the customer loyalty reward is dependent on a number of other customers that transacted money with the business since a last visit to the business by the customer in response to a previous promotional code shared by the customer with the other customers.

14. The method of claim 1, wherein the promotional code is associated with a current transaction with a business or company.

15. The method of claim 14, wherein receiving the indication of use of the promotional code within the limited time occurs before payment by the customer.

16. The method of claim 1 wherein the associating the promotional code with the order for goods or services includes associating the promotional code with information associated with the device accessible by the customer.

17. The method of claim 1 further comprising:
sending the promotional code that is active for the limited time to a server after generating the promotional code, wherein the generating the promotional code is executed by a point of sale device; and
sending information identifying the goods or services of the order to the server after generating the promotional code.

18. A device configured to provide a service to a plurality of customers, the device comprising:
a promotional code generator that is capable of generating a promotional code that is active for a limited time, each promotional code corresponding to a customer;
an interface service capable of sending and receiving information to and from a point of sale device;
an authenticator configured to receive promotional codes and to activate a reward corresponding to a respective promotional code when the promotional code is sent electronically to the authenticator within the limited time; and
a recorder configured to record information associated with each promotional code sent to the authenticator.

19. The device of claim 18 wherein the promotional code generator is configured to generate a promotional code in response to the interface service receiving a request from the point of sale device.

20. The device of claim 18 wherein the recorder is further configured to record information related to a consumer redeeming a promotional code.

21. A system comprising:
circuitry for generating a promotional code that is active for a limited time;
circuitry for sending to a device, the device accessible to a customer, the promotional code that is active for the limited time;
circuitry for receiving the promotional code within the limited time; and
circuitry for delivering an indication of a customer loyalty reward to the customer after receiving an indication of use of the promotional code within the limited time.

22. The system of claim 21, wherein the circuitry for generating the promotional code that is active for the limited time is configured to re-issue the promotional code after the limited time.

23. The system of claim 21, wherein the circuitry for receiving the promotional code within the limited time is configured to receive identifying information from the device accessible to the customer, the identifying information corresponding to the device accessible to the customer, the customer or both the device accessible to the customer and the customer.

24. The system of claim 21, wherein the indication of the customer loyalty reward includes information that may be used to acquire the customer loyalty reward.

25. A computer program product comprising one or more tangible computer accessible storage media configured with instructions for executing the following process:
generating a promotional code that is active for a limited time;
sending the promotional code that is active for the limited time to a customer;
receiving an indication of use of the promotional code within the limited time; and
sending an indication of a customer loyalty reward to the customer after receiving the indication of use of the promotional code within the limited time.

26. The computer program product of claim 25, wherein the limited time is variable and the promotional code is active for as long as the customer is within a predetermined geographical area associated with the customer loyalty reward.

27. The computer program product of claim 25, wherein the limited time is variable and the promotional code is active for as long as the customer is within a predetermined geographical area associated with a business location.
